(19) United States
(12) Patent Application Publication
(10) Pub. No.: US 2026/0106453 A1
(43) Pub. Date: Apr. 16, 2026

(54) MODULAR SPA CONTROLLER WITH VARIABLE FREQUENCY DRIVE

(71) Applicant: Balboa Water Group, LLC, San Diego, CA (US)

(72) Inventors: Raymond Carr, Lutz, FL (US); Morgan Lowery, Deforest, WI (US); Leopold Brunette, Madison, WI (US); Chris Sherwin, Stoughton, WI (US)

(21) Appl. No.: 19/379,498

(22) Filed: Nov. 4, 2025

Related U.S. Application Data
(63) Continuation-in-part of application No. 19/358,268, filed on Oct. 14, 2025.
(60) Provisional application No. 63/707,879, filed on Oct. 16, 2024.
(60) Provisional application No. 63/718,502, filed on Nov. 8, 2024.

(51) Int. Cl. H02J 1/04; H02P 23/00; H02P 27/06; H05B 1/02

(52) U.S. Cl. CPC H02J 1/04; H02P 23/00; H02P 27/06; H05B 1/0252

(57) ABSTRACT

A controller system for a bathing installation such as a spa, whirlpool bath or a pool, the bathing installation including a line voltage AC supply for selectively powering peripherals. The controller system includes an electronic controller configured to manage and control various peripherals such as heaters, pumps, and lights, by modulating the outputs to these peripherals, through the use of one or more Variable Frequency Drives (VFDs) for driving rotating loads and TRIACs with phase angle modulation for driving resistive loads. An exemplary embodiment also features a modular electronics design, allowing for flexible and customizable control of the spa system. Elements of the design include a high voltage bus, card edge connections, and the separation of high voltage and low voltage components.

### BACKGROUND OF THE INVENTION

This application claims priority to provisional Application Number 63/718,502, filed Nov. 8, 2024. This application is also a continuation-in-part of non-provisional Application Number Ser. No. 19/357,007, filed Oct. 13, 2025, which in turn claims priority to provisional Application Number 63/707879, filed Oct. 16, 2024. The entire contents of each of these applications are incorporated herein by this reference.

A bathing system such as a spa, whirlpool bath or a pool typically includes a vessel for holding water, pumps, a blower, a light, a heater and a controller for managing these features. The controller usually includes a control panel and a series of switches which connect to the various components with electrical wiring. Sensors detect water temperature and water flow parameters, and feed this information into the controller, which operates the pumps and heater in accordance with programming. Commonly owned U.S. Pat. Nos. 8,669,494; 7,236,692; 6,282,370; 5,361,215; 5,559,720 and 5,550,753, the entire contents of which are incorporated herein by this reference, show various methods of implementing spa control systems.

### SUMMARY

Exemplary embodiments of a controller system for a bathing installation such as a spa, whirlpool bath or a pool are described, the bathing installation including a line voltage AC supply for selectively powering peripherals. The controller system includes an electronic controller configured to manage and control various peripherals such as heaters, pumps, and lights, by modulating the outputs to these peripherals, through the use of one or more Variable Frequency Drives (VFDs) for driving rotating loads and/or TRIACs with phase angle modulation for driving resistive loads.

### BRIEF DESCRIPTION OF DRAWINGS

FIG. 1 graphically illustrates phase angle TRIAC modulation.

FIG. 2 is an exemplary embodiment of a TRIAC control schematic.

FIG. 3 is a schematic block diagram illustrating a spa system with TRIAC control of a resistive heater element.

FIG. 4 illustrates an exemplary embodiment of a variable frequency drive system.

FIG. 5 is a schematic diagram illustrating an exemplary embodiment of a spa controller employing variable frequency drive for high power spa components. FIG. 5A illustrates a conventional single-phase motor, using start and run capacitors and a centrifugal switch, powered by the spa controller of FIG. 5. FIG. 5B illustrates a motor driven by a spa controller as in FIG. 5 but modified to include a second inverter providing a first inverter output signal powering the main winding of the motor, and wherein the auxiliary winding is driven by the second inverter output provided by the spa controller.

FIG. 6 is a flow diagram illustrating an example of load shedding.

FIG. 7 diagrammatically illustrates features of an exemplary system controller featuring high voltage busbars and edge connections.

FIGS. 8A and 8B are schematic block diagrams illustrating an exemplary embodiment of a control system employing high voltage buses and card connectors.

FIG. 9 diagrammatically illustrates an example of a change in I/O cards in the system controller.

FIG. 10 illustrates an exemplary communication interface block diagram.

FIG. 11 illustrates an exemplary spa installation and operating environment for exemplary applications of the subject matter of this disclosure.

### DETAILED DESCRIPTION OF THE INVENTION

In the following detailed description and in the several figures of the drawing, some like elements are identified with like reference numerals. The figures are not to scale, and relative feature sizes may be exaggerated for illustrative purposes.

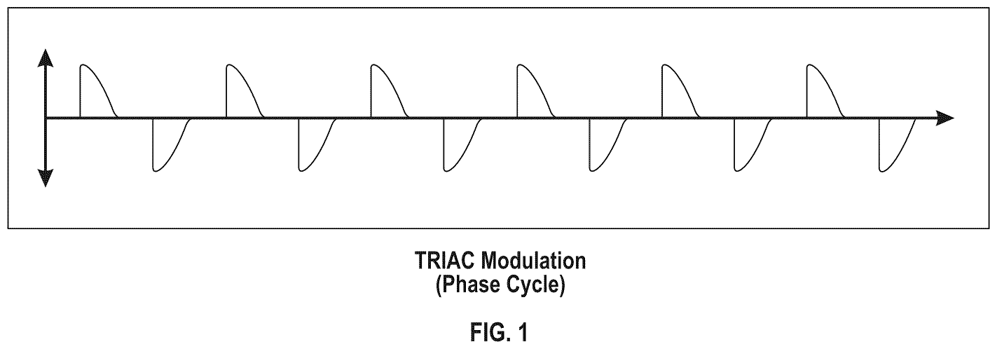

FIG. 1 illustrates an overall block diagram of an exemplary embodiment of a spa system. The system includes a vessel 1 for holding a volume of water, and a control system 2 to activate and manage the various parameters of the spa.

Connected to the vessel 1 through a series of plumbing lines 13 are pumps 4 and 5 for pumping water, a skimmer 12 for cleaning the surface of the vessel, a filter 20 for removing particulate impurities in the water, an air blower 6 for delivering therapy bubbles to the vessel through air pipe 19, and an electric heater 3 for maintaining the temperature of the spa at a temperature set by the user. In an exemplary embodiment, the electric heater 3 includes one or more resistive heating coils or elements 3A and a heater shell 3B. In an exemplary embodiment, the heater shell may comprise stainless steel. In FIG. 1, the heating elements are shown in the fluid flow path. Generally, a light 7 is provided for internal illumination of the water.

Service voltage power is supplied to the spa control system at electrical service wiring 15, which can be 120V or 240V single phase 60 cycle, 220V single phase 50 cycle, or any other generally accepted power service suitable for commercial or residential service. An earth ground 16 is connected to the control system and there through to all electrical components which carry service voltage power and all metal parts. Electrically connected to the control system through respective cables 9 and 11 are the control panels 8 and 10. All components powered by the control system are connected by cables 14 suitable for carrying appropriate levels of voltage and current to properly operate the spa. Water is drawn to the plumbing system generally through the skimmer 12 or suction fittings 17 and discharged back into the vessel through therapy jets 18. The current or power provided to operate the heater 3 is controlled by the control system 2.

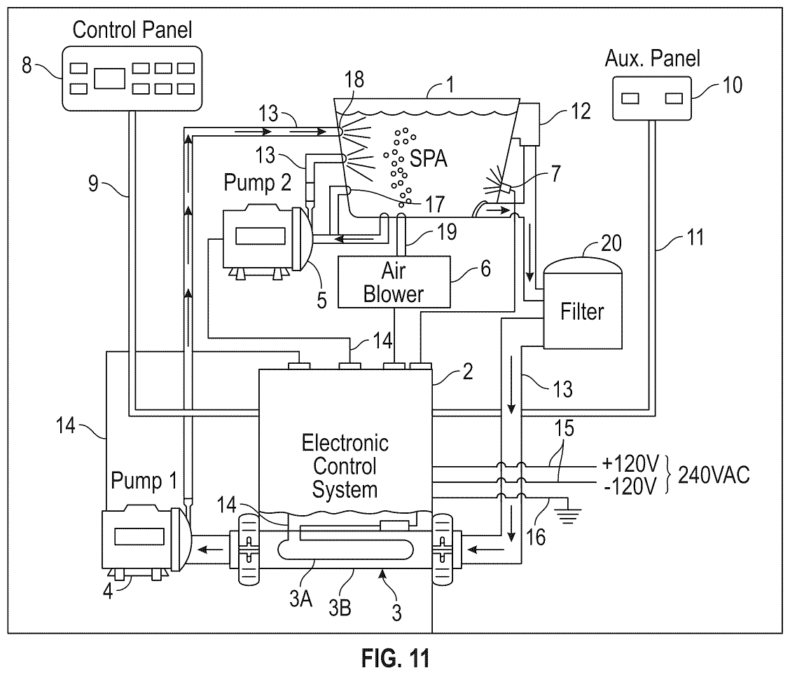

In accordance with one aspect of the invention, a spa controller is configured to manage and control various peripherals in hot tubs and spas, such as heaters, pumps, and lights, by modulating the outputs to these peripherals, through the use of Variable Frequency Drives (VFDs) and/or TRIACs with phase angle modulation. An exemplary spa installation is shown in FIG. 11, but other configurations may employ features of the invention, such as swim spas, pools and whirlpool baths.

### TRIACs With Phase Angle Modulation

TRIACs (Triode for Alternating Current) are semiconductor devices used to control power output to resistive loads, such as heaters. Fine power control is achieved through phase angle modulation, which allows for smooth and continuous adjustment of power output, providing precise control over the heating elements. This results in improved efficiency, as efficient power regulation reduces energy wastage and enhances the overall performance of the heating system. In an exemplary embodiment of a spa controller, TRIACs modulate power output to resistive loads such as heaters, ensuring precise and efficient heating control. The exemplary embodiment implements phase angle control by:

Triggering Mechanism: A gate pulse is applied to the TRIAC at a specific point in the AC voltage cycle to initiate conduction. The timing of this gate pulse is determined based on the required power output.

Phase Angle Modulation: The timing of the gate pulse, relative to the AC cycle, is varied to adjust the conduction angle of the TRIAC. This modulation controls the power delivered to the load; an earlier trigger in the cycle results in higher power delivery, while a later trigger reduces the power output. FIG. 1 illustrates phase angle TRIAC modulation.

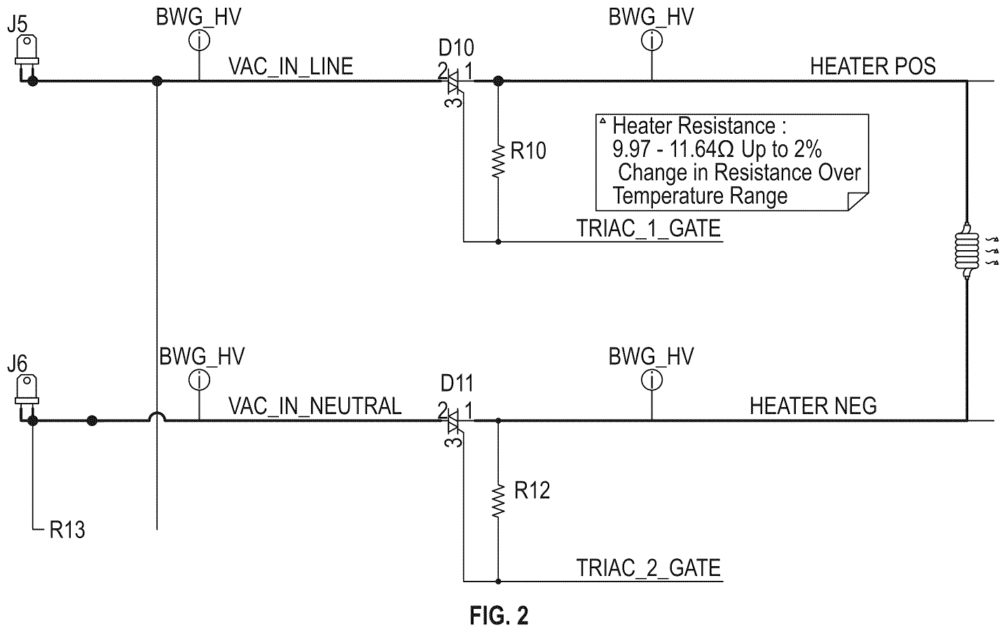

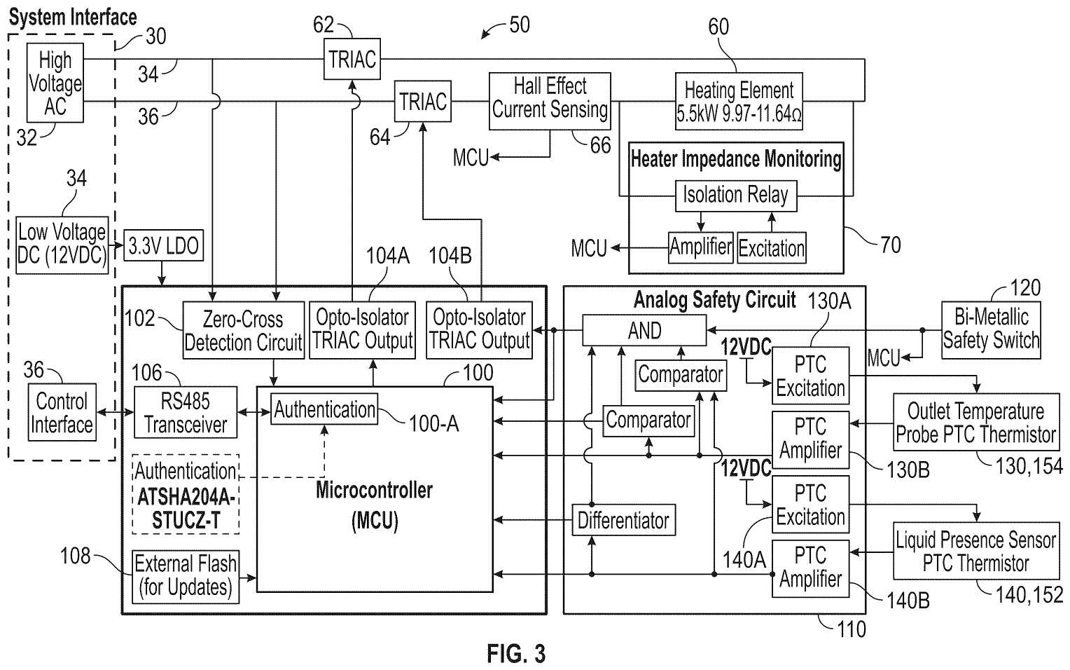

Control Circuit: An exemplary embodiment of a spa controller employs a control circuit to generate the gate pulses for the TRIACs. The controller with this circuit continuously monitors the desired power output and dynamically adjusts the gate pulse timing to achieve precise power control. The controller (shown in FIG. 3) monitors the current drawn by the heater and its impedance, so it calculates the power drawn by the heater. FIG. 2 is an exemplary embodiment of a TRIAC control circuit schematic.

FIG. 3 is a schematic block diagram illustrating aspects of a spa system with TRIAC control of a resistive heater element. This embodiment controls the application of AC power to a resistive heating element 60 which is configured to heat water pumped through a recirculating water flow path.

The heating control circuit 50 includes microcontroller (MCU) 100, and controls high voltage/current 32 entering the system from the system interface 30 on main lines 34, 36, regulating the AC power applied to the heating element 60 by two TRIACs 62, 64. While a single TRIAC could be used, a redundant one is included for safety. Current is monitored by current sensor 66 from these main lines 34, 36 for power consumption and monitoring applications. Additionally, the impedance of heating element 60 may be measured by impedance monitoring circuit 70.

In an exemplary embodiment, a bimetal switch 120 is used for temperature limiting and control. The system features zero-crossing detection through zero-crossing detection circuit 102 to ensure that the switching circuits (including TRIACs 62, 64) are precisely synchronized with the AC waveform, preventing circuit breakers from tripping. The control circuit includes temperature sensors 130, 140, typically placed adjacent the input and output ports of the heater housing, but other locations may also be employed.

This exemplary embodiment also includes communication capabilities, allowing it to be commanded by a user interface (UI) or other control devices. In this exemplary embodiment, a RS485 transceiver 106 is connected to a control interface 36 of the system interface 30. This provides communication between the control interface and an authentication function 100-A implemented in this embodiment by the microcontroller 100. The authentication function is provided to ensure that only authentic heater systems are under control of the UI. An exemplary authentication method and system is described in US Patent Application Ser. No. 18/368,560, filed Sep. 14, 2023, the entire contents of which application is incorporated herein by this reference. Opto-isolation between the TRIACs and the microcontroller 100 is implemented by opto-isolators 104A, 104B to ensure that connections to external displays or devices are safe for the user.

### Heating Control:

Heating elements used in water heating applications are generally simple devices that act as resistors, enclosed in a tube or housing placed in the water path. The resistance value of these elements is fixed, meaning that traditionally, different heating elements would need to be installed to accommodate varying voltages and currents at different installation sites. However, in a universal input heater in accordance with an aspect of this invention, a single resistance heating element 60 of a given power rating (e.g. one rated at 6.5 kW), and with a nominal resistance (9.97-11.64 ohms in this example) is used, and electronic controls are incorporated to prevent circuit breakers from tripping. These controls tightly manage when the heating elements are energized to stay within the limits of the trip curves.

The electronic control circuit 50 switches the heating element 60 using one, or a combination, of the methods described below, making the fixed resistance element appear as though it has different resistances. For example, a 2kW heater switched at a 50% duty cycle appears as a 1 kW heater. This allows the system to control the apparent resistance and optimize power usage, regardless of the current and voltage available at the installation site. Switching a heater element at different duty cycles allows the same heating element to be used across different current and voltage input conditions, such as 120 VAC and 240 VAC. This capability is tied to control over the apparent resistance of the heater. For example, a 5kW heater designed for 120V would require a resistance of approximately 2.9 Ohms. However, for the same 5 kW output on a 240V circuit, the resistance needs to be around 11.5 Ohms. By adjusting the duty cycle to around 25%, the heater's 2.9 Ohm element can behave as though it has an apparent resistance of 11.5 Ohms, allowing it to operate safely and efficiently at 240V. Similarly, a 2.9 Ohm heater on a 120V circuit would require a 40 Amp circuit breaker to run at full capacity. By regulating the duty cycle to 50%, the power output is reduced, allowing the heater to operate on a 20 Amp circuit, though at a lower total power output. This flexibility allows the heater to adapt to different input conditions while maintaining safe operation across varying voltage and current levels.

This flexibility is achieved by exploiting the time component of circuit breakers, momentarily exceeding the trip current but de-energizing the circuit before the breaker trips. In the 120V example, the current drawn by the heater can momentarily exceed the 20 Amp limit without causing the circuit breaker to trip, due to the inherent time-delay feature of standard circuit breakers. This time component is described by the circuit breaker's trip curve, which defines how long a circuit can exceed its rated current before the breaker trips. Circuit breakers are designed to tolerate brief overcurrent conditions without immediately disconnecting power. For instance, a 20 Amp breaker may allow currents above 20 Amps for a short duration before tripping, depending on the severity of the overcurrent and the time it persists. By carefully controlling the duty cycle of the heater, the system can exploit this trip curve. The current may exceed 20 Amps momentarily, but it is switched off before the time threshold defined by the trip curve is reached. This prevents the breaker from tripping,

A TRIAC is a circuit element commonly used to rapidly switch AC power systems on and off. To minimize average power consumption and prevent tripping circuit breakers, detection circuit 102 detects the zero crossings of the waveforms, allowing for the precise control of full AC cycles. This is desirable from an EMI/EMC compliance standpoint and generally better for power generation and distribution systems. Utilizing phase control with TRIACs (FIG. 1) offers similar average current reductions as using full cycle modulation, but provides greater control over peak currents.

### Variable Frequency Drives

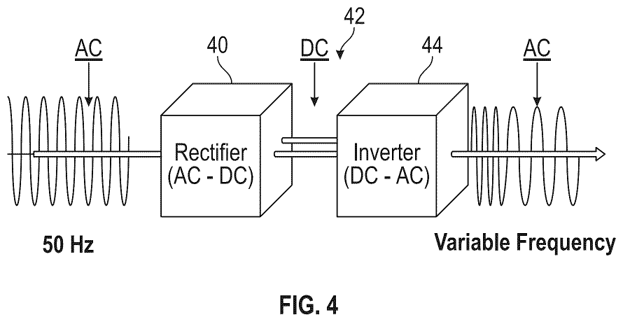

Variable Frequency Drives (VFDs) are used to control the speed and power usage of pumps and other rotating components, and may also be used to drive resistive elements. They enhance energy efficiency by adjusting motor speed to match the required load, thereby reducing energy consumption. VFDs provide precise control over motor speed, which is essential for applications that need variable flow rates or speeds. By reducing mechanical and electrical stress on the motor and related equipment, VFDs can extend the operational life of these components. Additionally, with optional Power Factor Correction (PFC), VFDs can significantly improve power quality and reduce overall power consumption. In accordance with aspects of the invention, an exemplary embodiment of the spa controller implements VFD control by the following process, illustrated in FIG. 4:

Rectification: The alternating current (AC) input power (50 Hz in this example) is converted into direct current (DC) voltage through a rectifier circuit 40. This rectified DC voltage provides the input for the subsequent stage.

DC Bus Stabilization 42: The rectified DC voltage is filtered and stabilized using capacitors within the DC bus, ensuring a steady DC voltage with minimal ripple.

Inversion: The stabilized DC voltage is inverted back to AC with adjustable frequency and amplitude via an inverter 44. The inverter comprises switching devices such as MOSFETs or IGBTs (insulated-gate bipolar transistors), controlled by pulse-width modulation (PWM) techniques.

Optional Power Factor Correction (PFC): To improve the efficiency and reduce the reactive power in the system, an optional power factor correction stage can be implemented. PFC circuits adjust the power factor to be closer to unity, thereby minimizing losses and improving overall system efficiency.

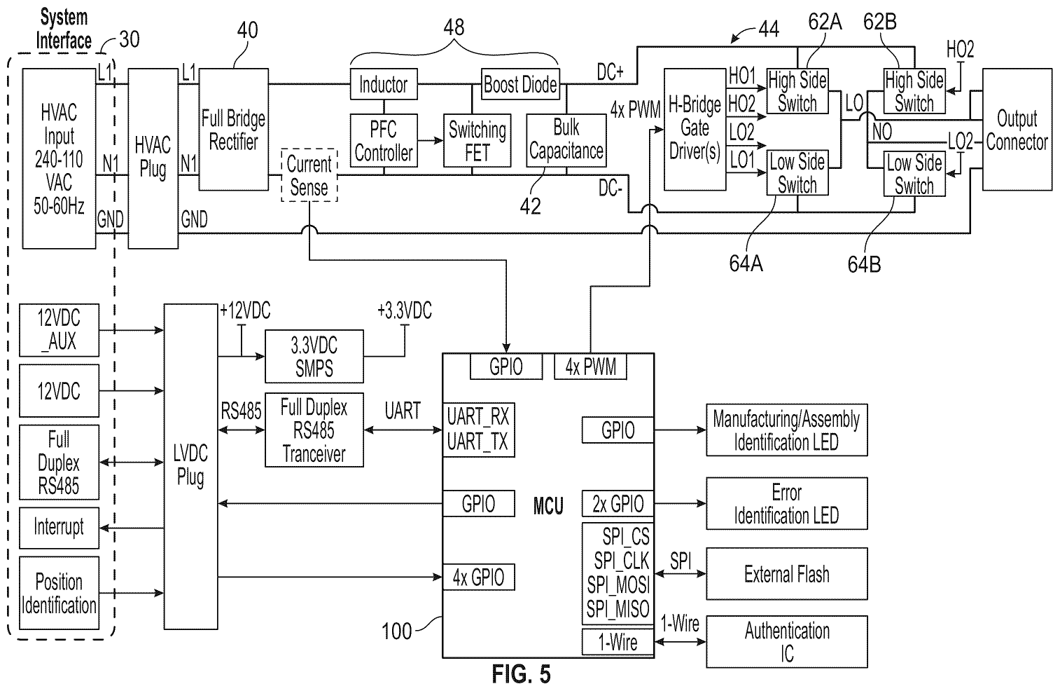

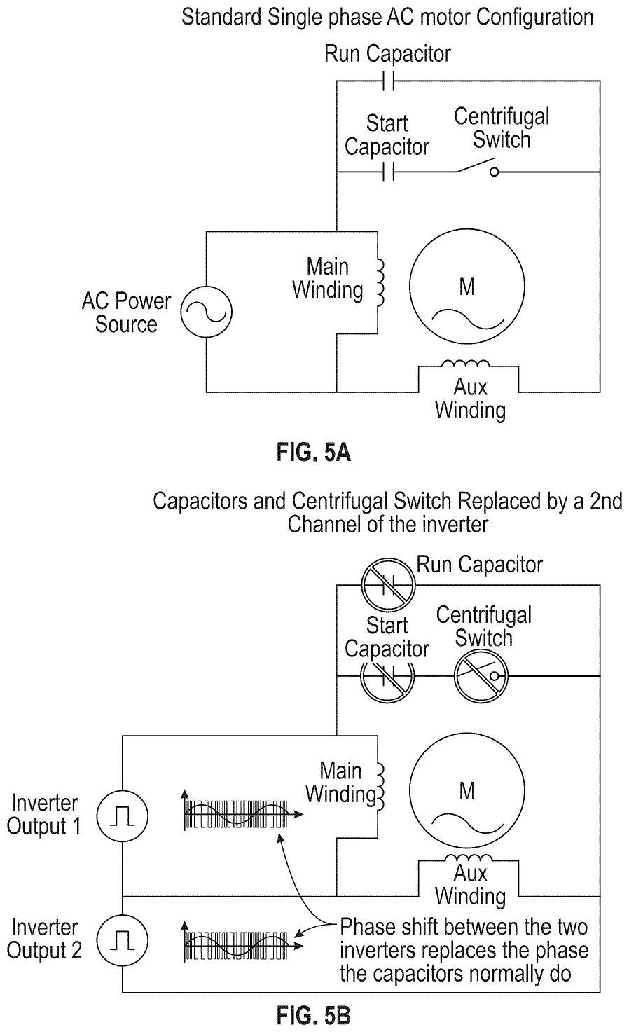

FIG. 5 is a schematic diagram illustrating an exemplary embodiment of a spa controller employing variable frequency drive for high power spa components. The system includes a full bridge rectifier 40, optional PFC circuit 48, DC stabilization 42 and H-bridge inverter 44 with high-side switches 62A, 62B and low side switches 64A, 64B under control of the MCU 100 to produce a VFD output. The output connector is available for loads such as a pump motor, other rotating loads, and even resistive loads. In an exemplary bathing installation, the controller may typically implement both the current control of the heater current as illustrated in FIG. 3 with the variable frequency drive functions shown in FIG. 5.

Motor Control: The frequency of the AC voltage output to the output connector is modulated to control the rotational speed of the motor. The voltage is also adjusted to maintain an appropriate voltage-to-frequency ratio, optimizing motor performance and efficiency.

In an exemplary embodiment, the controller and VFD of FIG. 5 is configured specifically to control single-phase motors with increased flexibility and efficiency. FIG. 5A illustrates a conventional single-phase motor, using start and run capacitors and a centrifugal switch, powered by an AC source, in this case the inverter output of FIG. 5. By varying the input frequency, the VFD directly adjusts motor speed for capacitor-run, capacitor-start, or dual-capacitor configurations. This adjustment is based on the motor speed, acceleration, and load, and it changes the apparent voltage by shifting the phase between the main and auxiliary windings of the motor. The capacitor configuration shown in FIG. 5 is how that phase shift is created. The two windings act as electromagnets that produce the rotating magnetic field which makes the motor turn. For that to happen, the fields from the two windings cannot be in phase, otherwise they would only pull the rotor to one position instead of causing rotation. The AC waveform naturally alternates polarity, which flips the magnetic field, but the capacitor provides the time delay between the main and auxiliary windings so the fields are not synchronized. That phase difference is what creates rotation.

Different capacitor setups change the timing of that phase shift to improve performance under different operating conditions. Most capacitors are designed to work best at a single frequency, but by using an adjustable configuration, we can modify the phase shift across frequencies can be modified. Since the magnetic field reversal is tied to the AC frequency, controlling that frequency directly controls the motor speed. Adjusting frequency enables precise control over motor speed to meet specific application needs.

In accordance with an aspect of the invention, the VFD may also include a two-phase output mode, eliminating the need for capacitors in single-phase motors. In this mode, the VFD supplies the primary winding with one phase while providing a second, variable-phase-offset to the auxiliary winding. This dual-phase approach departs from traditional three-phase VFDs, which typically deliver 120-degree phase shifts to each of three windings. By offering a variable phase offset between the primary and auxiliary windings, this VFD ensures optimal starting torque and effective speed control for single-phase motors.

FIG. 5B illustrates this feature. FIG. 5B illustrates a VFD providing an inverter 1 output signal powering the main winding of the motor. In this case, the capacitors and centrifugal switch are omitted, and the auxiliary winding is driven by the second inverter output provided by the VFD. In this example, the inverter 44 of FIG. 5 and the output connector are duplicated, so that the inverter 1 output signal is provided at the first output connector (as shown in FIG. 5) and the inverter 2 output is provided at the duplicate output connector. The MCU provides the control signals to the inverter to provide a variable phase offset between the primary and auxiliary windings.

Additionally, the VFD may incorporate Volts/Hertz (V/Hz) control, which maintains a consistent voltage-to-frequency ratio. By adjusting voltage in proportion to frequency, this feature ensures efficient torque output across varied speeds, improving energy efficiency, especially at reduced motor speeds.

### Load Shedding:

Load shedding is an important process in managing the power consumption of complex systems, ensuring that the total electrical load does not exceed the available power supply. In general, load shedding involves selectively reducing or adjusting the power supplied to various components, which prevents overload conditions and maintains system stability. This is essential for optimizing energy usage, protecting electrical infrastructure, and ensuring the reliable operation of the system.

In the context of a spa system, load shedding is particularly important due to the high power demands of components such as heaters, pumps, and lighting. Without load shedding, simultaneous operation of these components could lead to excessive power consumption, potentially tripping circuit breakers or blowing fuses. This not only disrupts the operation of the spa but can also cause damage to electrical components and shorten their lifespan due to overheating and high operational stress.

An exemplary embodiment of a spa controller in accordance with aspects of this invention employs load shedding to manage these high-power demands efficiently. By dynamically adjusting the power distribution to various components, the controller ensures that critical functions remain operational while preventing overload conditions. For instance, during peak demand periods, the controller can reduce the heater's temperature setpoint and lower pump speeds instead of shutting off components entirely. This approach maintains essential functionality while optimizing energy usage.

To implement load shedding effectively, an exemplary embodiment of the controller uses the methods previously described, including TRIAC phase angle modulation and VFD (Variable Frequency Drive) modulation. These techniques allow for precise control of power output to resistive loads like heaters and the adjustment of motor speeds for pumps and other rotating components.

An exemplary embodiment of a spa controller can utilize several strategies for load shedding. The controller may be programmed with preconfigured priorities that determine which loads to shed first during high demand periods.

Schedule-based priorities can also be used, where load shedding is activated during known peak usage times. Additionally, the controller may incorporate machine learning and artificial intelligence (AI) models to anticipate load demands based on historical data and current usage patterns. For example, if the system identifies that a user typically turns on infrared heaters after activating the jets, it can preemptively reduce the power to the heater to balance the load.

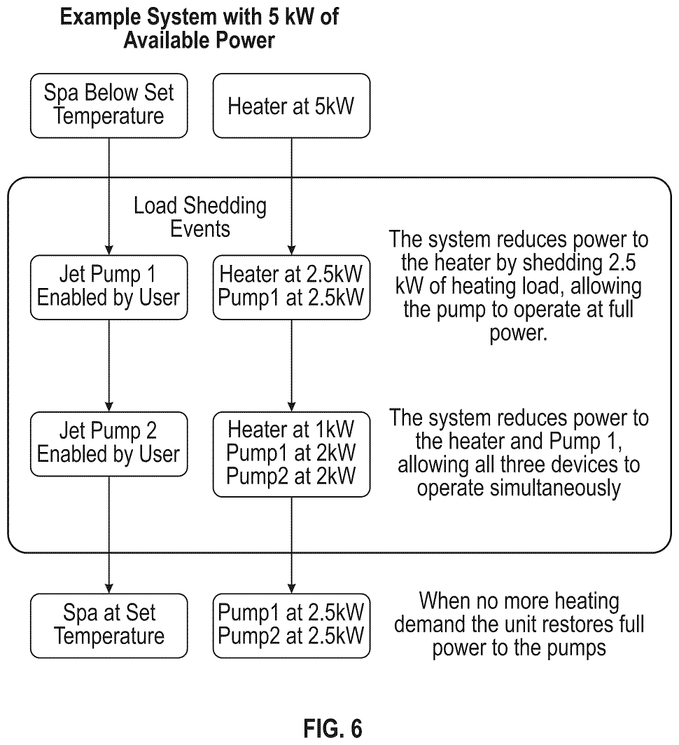

FIG. 6 is a flow diagram illustrating an example of load shedding in accordance with an aspect of the invention. In this example, the system has 5 kW of available power. With the spa water temperature below its set temperature, the heater is energized using the 5 kW of power. Now the jet pump 1 is enabled by the user. In a load-shedding event, the heater power is reduced to 2.5 kW, and pump 1 is energized with 2.5 kW power. Now, assume the user enables jet pump 2. In a further load-shedding event, the heater power is reduced to 1 kW, and pumps 1 and 2 are energized each at 2 kW. The heater power is controlled by TRIAC phase angle modulation, and the pump power is controlled by VFD modulation in this example.

By employing these strategies, the control system manages power consumption efficiently, ensuring that the spa system operates reliably and safely without requiring upgrades to the existing power supply. This advanced load shedding capability allows the control system to provide a robust and energy-efficient spa experience, maintaining system stability and protecting electrical components from damage.

### Modular Design:

In accordance with an aspect of the invention, an exemplary embodiment of a spa controller features a modular electronics design, allowing for flexible and customizable control of the spa system. Elements of the design include a high voltage bus, card edge connections, and the separation of high voltage and low voltage components to ensure safety and adaptability.

### High Voltage Bus and Card Edge Connections

### High Voltage Bus:

Function: A dedicated high voltage bus provides power to components that require higher electrical loads, such as heating elements and pumps.

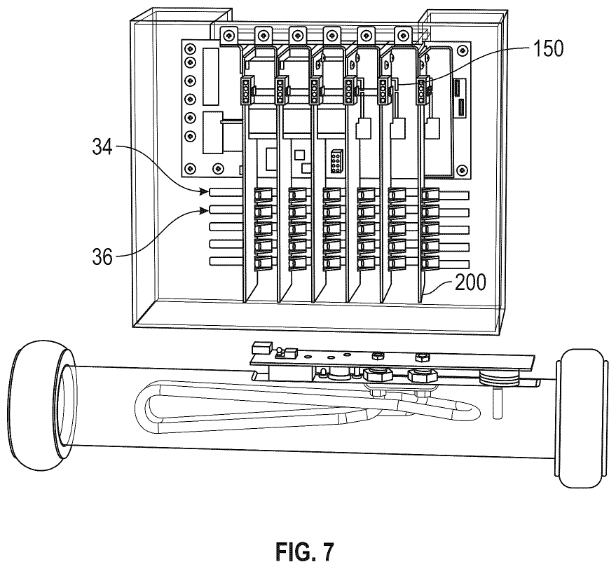

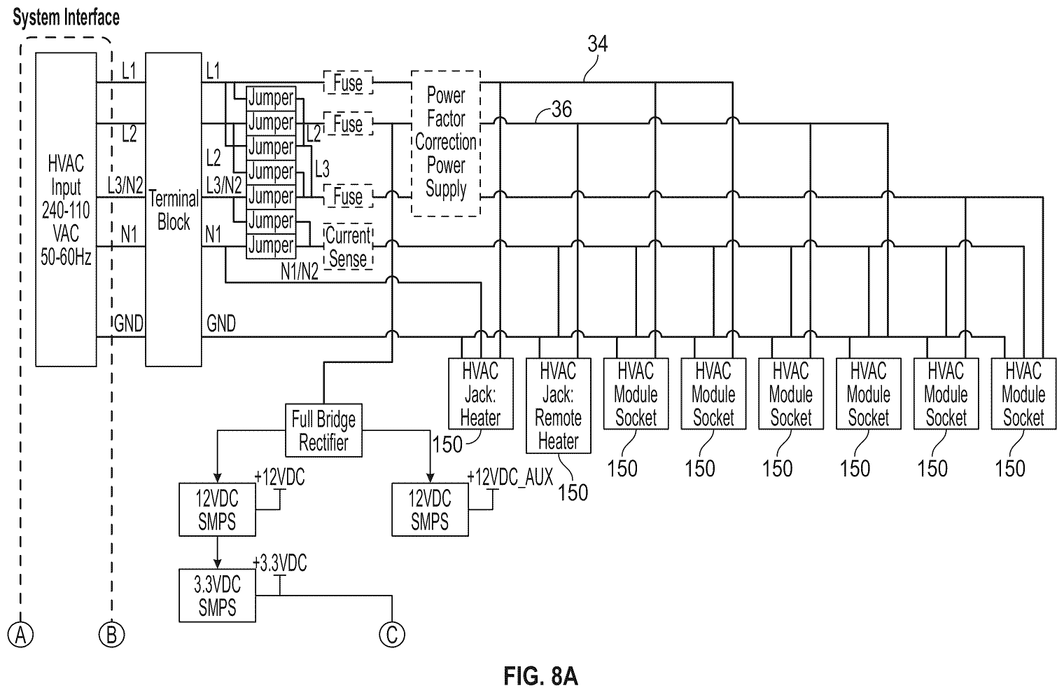

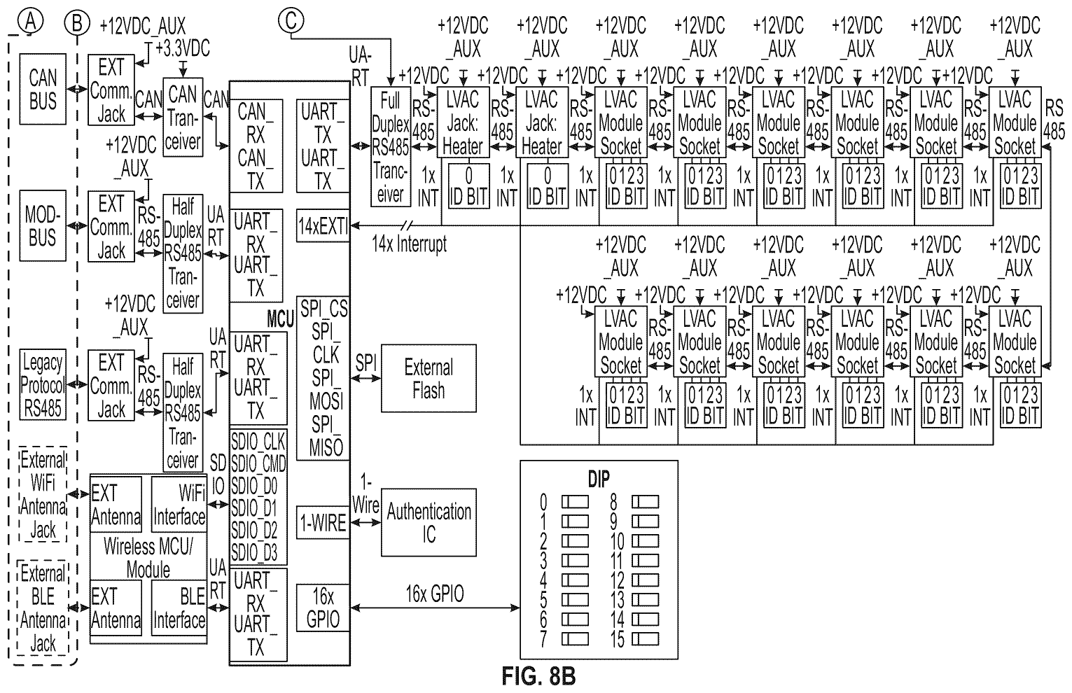

Safety: The high voltage bus is separated from low voltage circuitry to ensure safety and reduce interference, with clear isolation between the two voltage domains. FIG. 7 diagrammatically illustrates features of an exemplary system controller featuring high voltage busbars including 34, 36 and edge connections 150. FIGS. 8A and 8B are schematic block diagrams illustrating an exemplary embodiment of a control system employing high voltage busses 34 36 and card or edge connectors 150.

### Card Edge Connections:

Modularity: The card edge connections allow for modular expansion by enabling different input/output (I/O) cards to be inserted into the controller. FIG. 7 illustrates I/O cards including I/O card 200 These cards can be tailored to specific system requirements, allowing for a highly customizable setup. As shown in FIGS. 8A and 8B, the cards may include low voltage AC module sockets as well as high voltage AC sockets.

Flexibility: The modularity enables the system to accommodate various configurations, including differing numbers and types of inputs and outputs, without needing to redesign the entire system.

### Automatic Control Logic Adaptation

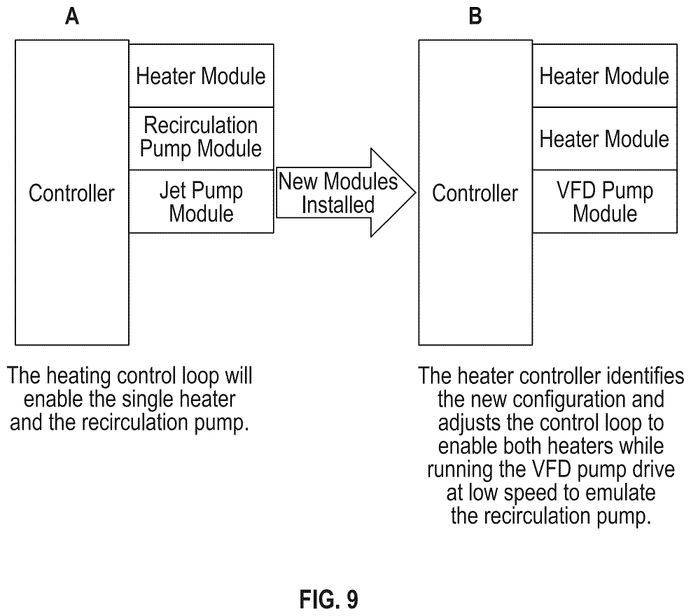

Customization: When new I/O cards are inserted into the system, the control logic programmed into the microcontroller automatically adapts based on the new inputs and outputs. This dynamic adaptation eliminates the need for manual reprogramming and simplifies system upgrades or modifications. FIG. 9 diagrammatically illustrates an example of a change in I/O cards in the system controller. In configuration A, the controller has installed in the high voltage AC sockets a heater module, a recirculation pump module and a jet pump module. In configuration A, the heating control loop carried out by the microcontroller will enable operation of the single heater and the recirculation pump. Now new modules are installed to change the system to configuration B. The recirculation pump module is replaced with a second heater module, and the jet pump module is replaced with a VFD pump module. The controller identifies the new configuration and adjusts the control loop to enable operation of both heaters while running the VFD pump drive at low speed to emulate the recirculation pump.

The modules may include the HVAC rectifier circuit elements. Alternatively, the control system may include one centralized rectifier circuit serving all modules, which then have the inverter circuit incorporated in the VFD module(s). Having one centralized rectifier for the system is more cost-efficient than placing one on each module, when multiple modules are used to serve multiple loads such as heaters and pumps. The module(s) serving resistive loads will incorporate the TRIAC switching circuitry.

Modular Expansion: The ability to add or replace cards with minimal configuration changes enables scalability and ease of maintenance, ensuring that the spa controller can be updated with new functionalities as needed.

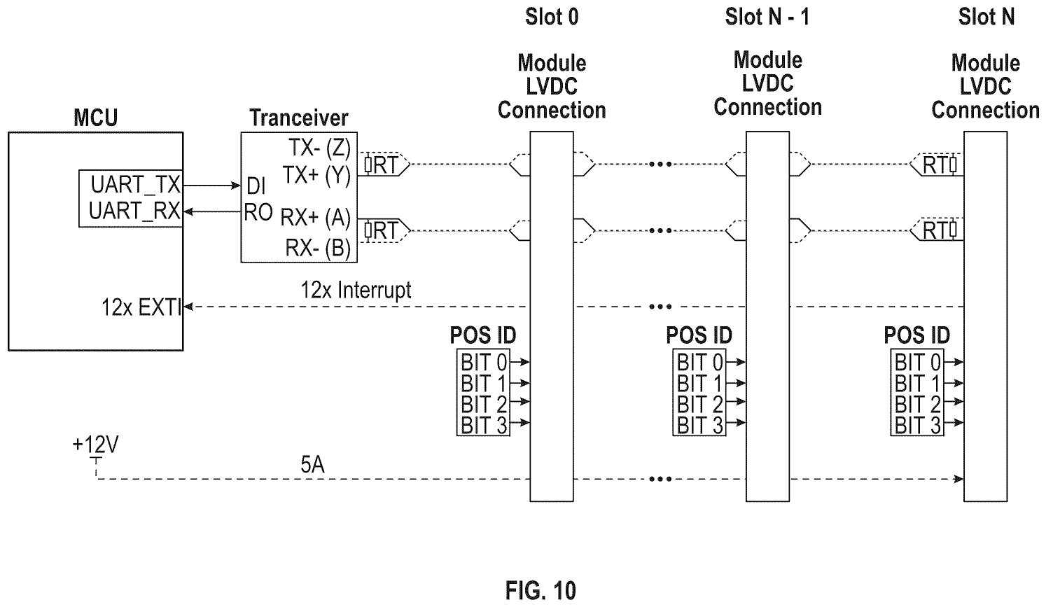

In an exemplary embodiment, the modular expansion is facilitated by use of a common set of interfaces by all modules to communicate with the host printed circuit board and the electronic controller (MCU). FIG. 10 illustrates an exemplary communication interface block diagram for the low voltage sockets or card slots. The same arrangement applies to the high voltage sockets or card slots. The set of interfaces in one exemplary embodiment includes a primary communication interface including a transceiver to transmit commands to the sockets, an interrupt interface, a position identification interface which identifies the position of the module, and a DC power supply. The microcontroller through the communication interface identifies the type and slot position of each module through the position identification interface, and controls the operation of the respective modules through signals sent through the communication interface.

Although the foregoing has been a description and illustration of specific embodiments of the subject matter, various modifications and changes thereto can be made by persons skilled in the art without departing from the scope and spirit of the invention.

1. A controller system for a bathing installation, the bathing installation including a line voltage AC supply for selectively powering peripherals, the controller system comprising:
an electronic controller configured to manage and control various peripherals including one or more heaters and rotating loads including a pump by modulating the power outputs to these peripherals, through the use of a variable frequency drive (VFDs) for driving the rotating load;
wherein the VFD comprises:
a rectifier circuit for converting the line voltage AC supply into a DC voltage;
a DC bus stabilization circuit configured for filtering and stabilizing the DC voltage to provide a steady DC voltage; and
an inverter configured for inverting the stabilized DC voltage back to an AC voltage with adjustable frequency and amplitude to drive a pump motor or other rotating component, wherein the inverter frequency and amplitude are controlled by the electronic controller.

2. The system of claim 1, wherein the electronic controller is configured to modulate the frequency of the AC voltage output from the inverter to control the rotational speed of the motor, and to adjust the voltage amplitude to maintain an voltage-to-frequency ratio, optimizing motor performance and efficiency.

3. The system of claim 1, wherein the electronic controller further comprises one or more TRIACS controlled with phase angle modulation to drive resistive loads; and
wherein said one or more TRIACs are configured to control application of line voltage AC power to a heater element, and wherein the electronic controller is configured to generate gate pulses to control the conduction angle of the one or more TRIACs to modulate application of power to the heater element.

4. The system of claim 1, wherein the electronic controller is configured to manage the power consumption of the peripheral components to ensure that the total electrical load does not exceed the available power supply, by selectively reducing or adjusting the power supplied to the peripheral components to prevent overload conditions and maintain system stability.

5. The system of claim 4, wherein the electronic controller is configured to dynamically adjust the power distribution to peripheral components to ensure that critical functions remain operational while preventing overload conditions.

6. The system of claim 5, wherein the electronic controller is configured to reduce the heater setpoint and to lower pump speeds instead of shutting off the heater and pump entirely.

7. The system of claim 6, wherein the electronic controller is configured to employ TRIAC phase modulation and VFD modulation to control application of electrical power to the heater and the adjustment of pump motor speed.

8. The system of claim 4, wherein the electronic controller is programmed with preconfigured priorities that determine which loads to shed or to reduce power consumption first during high demand periods.

9. The system of claim 4, wherein the electronic controller is programmed with schedule-based priorities, wherein load shedding is activated during known peak usage times.

10. The system of claim 4, wherein the electronic controller is configured to incorporate machine learning and AI models to anticipate load demands based on historical data and current usage patterns.

11. The system of claim 1, wherein the electronic controller has a customizable modular electronics design, including a high voltage bus, card edge connections, and the separation of high voltage and low voltage components to ensure safety and adaptability.

12. The system of claim 11, comprising a dedicated high voltage bus configured to provide power to components that require higher electrical loads, including heating elements and pumps, and wherein the high voltage bus is separated from low voltage circuitry to ensure safety and reduce interference, with clear isolation between low voltage and high voltage domains.

13. The system of claim 11, further comprising a main circuit board on which are mounted a set of card edge connections, and wherein the card edge connections allow for modular expansion by enabling different input/output (I/O) cards to be inserted into the controller system, and wherein the cards are tailored to specific system requirements, and wherein the electronic controller includes a microcontroller and the set of card edge connections are connected to a communication interface, a position identification interface and an interrupt interface.

14. The system of claim 13, wherein the electronic controller includes a microcontroller programmed with a control logic that automatically adapts based on new inputs and outputs attributed to new I/O cards inserted into the controller system.

15. The system of claim 1, wherein the VFD is configured to control single-phase motors by varying the input frequency, to directly adjust motor speed for capacitor-run, capacitor-start, or dual-capacitor configurations.

16. The system of claim 1, wherein the VFD is configured to include a two-phase output mode, employing two output inverters, eliminating the need for capacitors in single-phase motors, wherein a first output inverter of the VFD supplies a primary motor winding with one phase and a second output inverter of the VFD provides a second, variable phase offset to a motor auxiliary winding.

17. A modular controller system for a bathing installation, the bathing installation including a line voltage AC supply for selectively powering peripherals, the controller system comprising:
an electronic controller including a microcontroller, the electronic controller configured to manage and control various peripherals including one or more heaters, pumps, and low voltage peripherals, by modulating the outputs to these peripherals, through the use of one or more Variable Frequency Drives (VFDs) for driving rotating loads and one or more switches for driving resistive loads;
a main circuit board on which are mounted a set of card edge connections, and wherein the card edge connections allow for modular expansion by enabling different input/output (I/O) cards to be inserted into the controller system, and wherein the cards are tailored to specific system requirements, and wherein each of the set of card edge connections are connected to a communication interface, a position identification interface and an interrupt interface.

18. The system of claim 17, wherein the set of card edge connections includes a heater card edge connection connected to the line voltage AC supply, and a heater I/O card configured for connection to said heater edge card connection, the heater I/O card including one or more TRIACs configured to control application of line voltage AC power to a heater resistive element, and wherein the electronic controller is configured to generate gate pulses to control the one or more TRIACs to modulate application of power to the heater element.

19. The system of claim 17, wherein the set of card edge connections includes a pump card edge connection connected to the line voltage AC supply, and a pump I/O card configured for connection to said pump edge card connection, the pump I/O card including a variable frequency drive (VFD) circuit configured to generate a variable frequency, variable amplitude drive signal to power a pump motor.

20. The system of claim 19, wherein the electronic controller includes a centralized rectifier circuit, and the VFD circuit of the pump I/O card includes an inverter.

21. The system of claim 19, wherein the VFD circuit of the pump I/O card includes a voltage rectifier circuit and an inverter circuit.

22. The system of claim 17, wherein the set of card edge connections includes a low voltage card connection connected to a low voltage supply, and a low voltage peripheral I/O card configured for connection to the low voltage card connection.
